(19) United States
(12) Patent Application Publication
(10) Pub. No.: US 2011/0243696 A1
(43) Pub. Date: Oct. 6, 2011

(54) POWERED HAND TRUCK WITH VERTICALLY MOVABLE PLATFORM

(76) Inventor: Joe DiBenedetto, Fullerton, CA (US)

(21) Appl. No.: 12/751,873

(22) Filed: Mar. 31, 2010

(51) Int. Cl. B62B 5/00; B66F 9/06; B66F 9/075; B62B 1/12

(52) U.S. Cl. 414/490; 187/231

(57) ABSTRACT

A powered hand truck comprises a vertically movable platform configured to raise and lower a weight of a full beer keg between a ground surface and a height of a truck loading surface. The powered hand truck may further comprise a motor configured to provide a force that enables the platform to be raised and lowered. A battery may be used to power the motor. In one embodiment, a chain and sprocket system may be used to transfer torque from the motor to a vertical force that enables controlled movement of the platform.

### BACKGROUND

1. Field of the Invention

The invention relates in general to the field of hand trucks for use in lowering, raising and transporting heavy items.

2. Description of the Related Art

When beer kegs and other heavy beverage containers are delivered to bars, restaurants and liquor stores, they often need to be raised into delivery trucks and then lowered back down to ground level upon arrival. In order to do this, the kegs are typically lifted and lowered down by a particularly strong person, or the truck is provided with a loading ramp of one type or another. Unfortunately, it is not always possible to use a loading ramp due to cost or to the space available at a drop-off location. Additionally, lowering kegs manually can be strenuous and dangerous for the person doing the lowering. Likewise, lifting kegs manually can also be very strenuous and dangerous for the person doing the lifting. A full keg of beer typically weighs between about 130 and about 170 pounds, so lifting and lowering a keg from a height of a truck (typically as high as about 68″) without a ramp can be a challenging task to accomplish without damaging the keg or injuring the worker.

Another attempted solution to the problem of transporting and delivering heavy items has been a hand truck that uses mechanical elements to provide controlled lowering of a platform. For example, mechanical elements that enable controlled lowering of a platform may comprise a pneumatic cylinder or other resistance device. With these devices, placing a heavy object on the platform when the platform is in a raised position will cause the platform to slowly descend. However, hand trucks that use resistance-based techniques to lower a platform supporting a heavy object only attempt to address half of the problem—lowering a heavy object from the height of a delivery truck. Notably, these hand trucks fail to adequately provide a solution to the problem of raising heavy objects from ground level to a shelf or truck height. The inability to both raise and lower heavy objects is a significant drawback to using hand trucks with resistance-based lowering techniques in the beer-keg and beverage transportation business. Furthermore, hand trucks utilizing resistance-based lowering techniques are usually biased with the platform in an elevated position, allowing the platform to be lowered only when a heavy object is placed on it. The inability for a hand-truck operator to easily control the height of the movable platform is yet another drawback that limits the effectiveness of hand trucks with resistance-based lowering techniques.

### SUMMARY OF THE INVENTION

Thus, it is desirable to provide a relatively simple and inexpensive device that allows a person to raise and lower a heavy object, such as a full keg of beer, between a height of a raised position such as a truck loading surface and a ground surface. Such a device is preferably configured to raise and lower heavy objects at a controlled rate.

According to one embodiment, a powered hand truck comprises a frame having a top portion, a bottom portion, and a longitudinal axis extending between the top portion and the bottom portion. The powered hand truck may also comprise at least one handle mounted to the frame adjacent to the upper portion, a pair of wheels attached to the frame adjacent to the bottom portion, and a platform having a substantially planar upper surface that is oriented substantially perpendicular to the longitudinal axis of the frame. In this embodiment, the platform is configured to move axially along the longitudinal axis while maintaining the perpendicular orientation of the platform.

In one embodiment, the powered hand truck further comprises a winch motor configured to provide a force that enables the platform to be raised and lowered. A battery may be used to power the motor. A chain and sprocket system may be used to transfer available torque from the winch motor to a vertical force that enables controlled movement of the platform. For example, in one embodiment, the powered hand truck may be configured to lift and lower a weight of up to about 170 pounds between a ground surface and a height of up to about 68″ at a controlled rate.

According to another embodiment, a raising and lowering device comprises at least one vertical frame member having a pair of wheels mounted to a bottom portion thereof, and at least one handle mounted to the at least one vertical frame member and extending rearwardly from the frame member. The device may further include at least one stabilizing leg mounted to the bottom portion of the frame member and extending forwardly to provide support for the device. In this embodiment, a generally planar platform is movably attached to the vertical frame member. The platform extends forwardly from the at least one frame member and is configured to move vertically along the vertical frame member. The handle may comprise controls to allow the hand-truck operator to control the movement of the platform.

In another embodiment, a method of vertically moving a heavy object between a height and a ground surface comprises placing the object on a platform that is vertically movable on a hand-truck frame. The method further comprises pressing a switch to activate a winch motor, wherein pressing the switch enables raising and lowering of the platform.

### BRIEF DESCRIPTION OF THE DRAWINGS

Having thus summarized the general nature of the invention, certain preferred embodiments and modifications thereof will become apparent to those skilled in the art from the detailed description herein having reference to the figures that follow, of which:

FIG. 1 is a perspective view of an embodiment of a powered hand truck with a movable platform shown in a “down” position.

FIG. 2 is a perspective view of the powered hand truck of FIG. 1 with a movable platform shown in a partially-raised position.

FIG. 3 is an elevational side view of an embodiment of a powered hand truck with a movable platform shown in a partially-raised position while loaded with a beer keg.

FIG. 4 is a schematic illustration of a side view of a sprocket assembly positioned at the top of an embodiment of a powered hand truck for use in facilitating movement of a chain.

FIG. 5 is a perspective view of a lower rear section of an embodiment of a powered hand truck with a movable platform shown in a “down” position.

FIG. 6 is a perspective view of a middle rear section of an embodiment of a powered hand truck.

FIG. 7 is a perspective view of a lower front section of an embodiment of a powered hand truck.

### DETAILED DESCRIPTION OF THE PREFERRED EMBODIMENTS

With reference to the attached figures, a powered hand truck with raising and lowering capability will now be described. The hand truck of the preferred embodiments generally includes a movable platform which can support a heavy object and which can be raised to a desired height or lowered to a ground surface at a controlled rate under direction of a hand-truck operator.

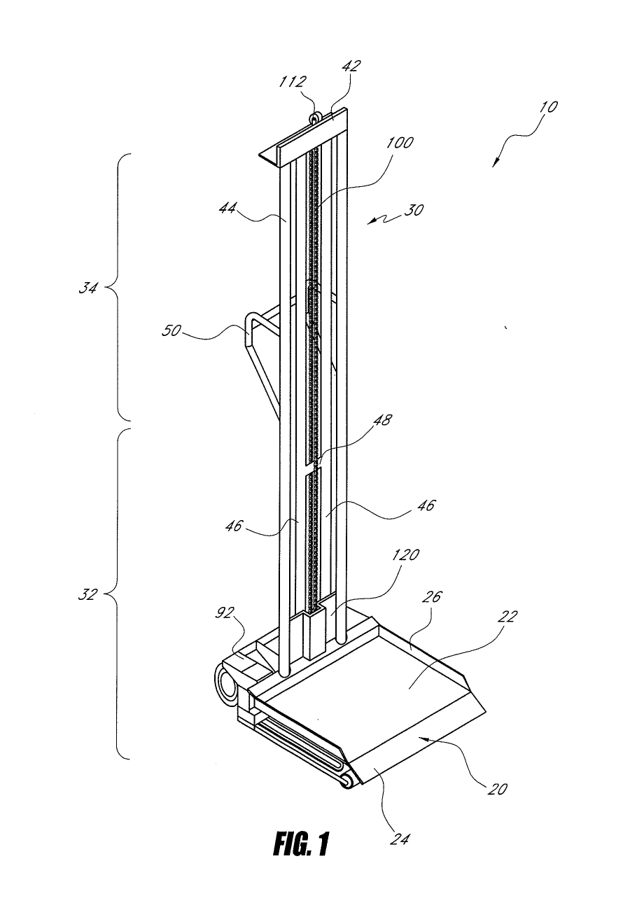

FIG. 1 illustrates one embodiment of a powered hand truck 10 comprising a platform 20, a handle 50, and a chain 100. In this embodiment, the chain 100 transmits a force that enables the platform 20 to be raised and lowered. In some embodiments, the powered hand truck 10 is configured to smoothly raise or lower a weight of up to about 170 pounds between a ground surface and a height of a truck loading bed or a storage container on a truck. In alternative embodiments, the powered hand truck 10 is configured to raise and lower heavier or lighter weights as desired. The height to which a weight may be raised or from which a weight may be lowered can vary depending on the height of the particular hand truck used. In a preferred embodiment, the powered hand truck 10 may generally be configured to enable the platform to vertically move between a ground surface and an upper position at a height of about 68″ to about 70″ above the ground. In some embodiments, in addition to raising and lowering a heavy object, the powered hand truck 10 may be configured to hold the platform 20 in place at any desired height along its vertical path.

In the illustrated embodiment of FIG. 1, the powered hand truck 10 comprises a frame 30, which may comprise vertically-extending side members 44 and central rods 46. Side members 44 extend along the height of the frame 30 and may be used to assist or guide the platform 20 along its vertical path. Similarly, central rods 46 extend along the height of the frame 30 and may guide the platform 20 along its vertical path. Central rods 46 may be connected by a middle cross member 48, which strengthens the structural integrity of the frame 30. The side members 44, the central rods 46, and the middle cross member 48 may comprise any suitable material sufficient to support the lifting and lowering of heavy objects on the platform 20. For example, the side members 44, the central rods 46, and the middle cross member 48 may comprise steel.

In the illustrated embodiment of FIG. 1, the powered hand truck 10 generally comprises a lower portion 32 and an upper portion 34. The lower portion 32 of the powered hand truck 10 generally comprises a base that supports the frame 30, a set of wheels, and a motor that provides a force that enables the platform 20 to be vertically moved. The motor may be powered by a battery. The lower portion 32 may additionally comprise a cover plate 92, which covers the battery and motor and protects the powered hand-truck operator from injury.

The upper portion 34 of the frame generally comprises a handle 50 and an upper cross plate 42. The handle 50 may comprise controls that enable the hand-truck operator to control the vertical movement of the platform 20. In other embodiments, these controls may be located elsewhere on the powered hand truck 10. Also, the handle 50 may be rigidly attached to the upper portion 34 of the frame 30 and extend rearward. The handle 50 may comprise any suitable material, and may be attached to the frame in any suitable manner. For example, the handle 50 may comprise sections of steel tubing welded to the frame 30. Although the illustrated embodiments show the powered hand truck with one handle, the skilled artisan will recognize that more handles could alternatively be provided.

The upper cross plate 42 may connect and extend across the vertically-extending side members 44 and central rods 46. In addition, the upper cross plate 42 may comprise steel and be welded to the frame 30. The upper cross plate 42 thereby increases the structural integrity of the frame 30. In addition, a sprocket housing 112 may be connected to the upper cross plate 42. The sprocket housing 112 comprises a sprocket that facilitates movement of the chain 100.

A connecting plate 120 may be configured to couple the platform 20 with the chain 100 and engage the central rods 46 of the frame 30. One end of the chain 100 may be attached to the connecting plate 120, and the tension in the chain 100 transmits a vertical force that enables the platform 20 to move vertically. For example, the chain 100 may be connected to the connecting plate 120 using a sprocket system. In addition, the connecting plate 120 may engage the central rods 46 of the frame 30. By engaging the central rods 46, the connecting plate 120 is guided along a fixed vertical path, which enables the controlled movement of the platform 20 along the fixed vertical path. In addition, the connecting plate 120 may include roller wheels that may be used to facilitate the motion of the connecting plate 120 along the central rods 46. Furthermore, a lubricant, such as an oil, may be used to reduce friction between the connecting plate 120 and/or roller wheels and the central rods 46, thereby improving efficiency and reducing wear.

In one embodiment, the platform 20 is about 19″ wide by about 19″ deep, and is made of a sufficiently rigid material that enables the platform 20 to support the weight of a desired load in a cantilevered manner. The platform 20 may also comprise a textured, knurled, patterned, or roughened surface to increase friction between the platform surface and the keg or other load placed thereon.

As shown in FIG. 1, the platform 20 may include a downward sloping edge surface 24 to facilitate loading of a beer keg or other weighted object onto the platform 20. As shown, the platform 20 may also include side guards 26 to prevent an object placed on the platform 20 from sliding sideways off of the sides of the platform 20. In the illustrated embodiment, the side guards 26 comprise rigid vertical members attached to the sides of the platform 20. In alternative embodiments, the side guards 26 may comprise rigid tubular sections that may attach to the upper surface 22 or side of the platform 20.

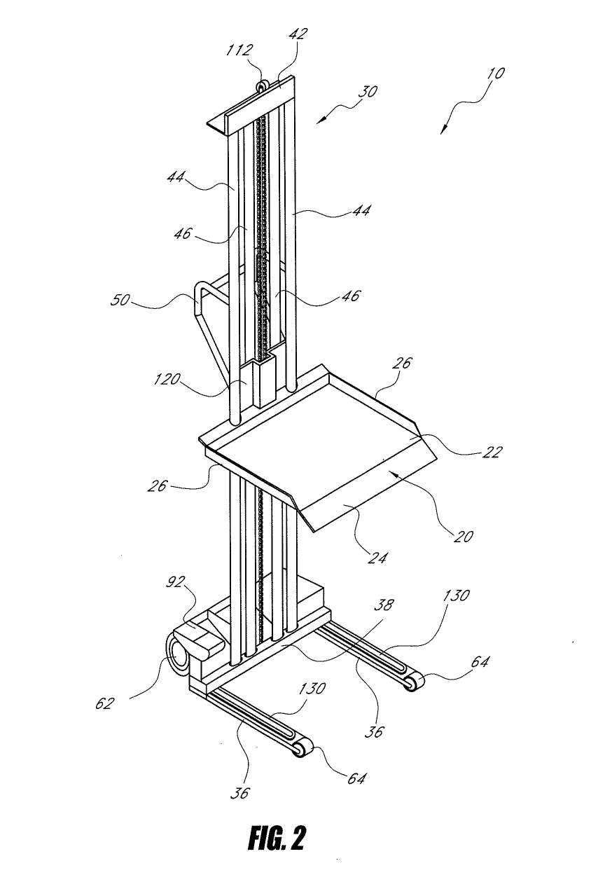

FIG. 2 illustrates the powered hand truck 10 of FIG. 1 with the platform 20 in a partially-raised position. As shown, the powered hand truck 10 may include stabilization legs 36 extending forwardly from the frame 30. The stabilization legs 36 preferably extend substantially the same distance from the frame 30 as the top surface 22 of the platform 20. This allows an object supported on the forward-most edge of the platform 20 to be supported by a portion of the stabilization legs 36 in contact with the ground vertically below the edge of the platform 20. The skilled artisan will recognize that shorter legs could alternatively be used, but using a leg that is similar in length to the platform provides a more stable support. In one embodiment, front wheels 64 may be provided for the stabilization legs 36 in order to allow the hand truck to be easily movable while in a vertical orientation. The front wheels 64 may generally be any size or type. In one embodiment, rubber bumpers 130 may be attached to the top of the stabilization legs 36 in order to provide a cushioned surface that may absorb and dissipate energy if the bottom of the platform 20 contacts the rubber bumpers 30.

As illustrated in FIG. 2, the frame 30 may comprise a lower cross plate 38. The lower cross plate 38 may connect and extend across the vertically-extending side members 44 and central rods 46. In addition, the lower cross plate 38 may comprise steel and be welded to the frame 30. The lower cross plate 38 thereby increases the structural integrity of the frame 30.

The rear wheels 62 mounted to the base of the powered hand truck 10 can generally be any size or type. In the illustrated embodiment, the rear wheels 62 are shown spaced rearward from the base of the powered hand truck 10 so as to provide additional stability, thereby preventing the powered hand truck from tipping backwards too easily.

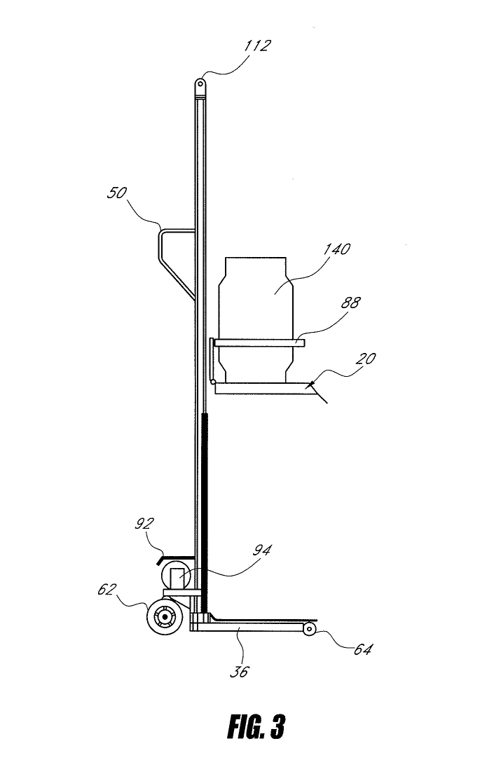

FIG. 3 illustrates a side view of an alternative embodiment of a powered hand truck with a movable platform 20 shown in a partially-raised position while loaded with a beer keg 140. In order to prevent the beer keg 140 from tipping over or becoming displaced while being raised or lowered, the beer keg 140 may be secured by a safety strap 88. Similarly, the safety strap 88 can be used to secure any other object being raised or lowered by the platform 20. In this embodiment, the battery 94 is located above the rear wheels 62.

Also shown in FIG. 3 is a battery 94, which may be used to supply power to an electric motor. The cover plate 92, illustrated in its down position, covers the battery and motor and protects the powered hand-truck operator from injury. Alternatively, the battery and/or motor can be enclosed in a cavity.

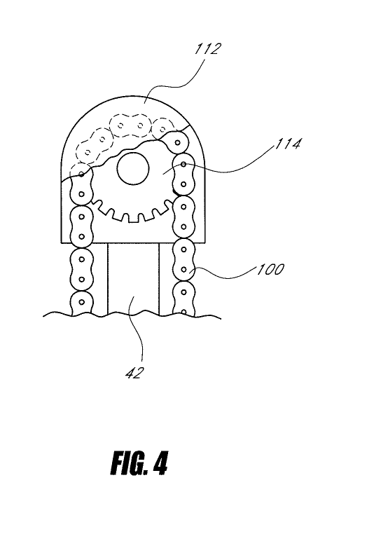

FIG. 4 illustrates a side view of a sprocket assembly located at the top of an embodiment of a powered hand truck for use in facilitating movement of the chain 100. In particular, a sprocket housing 112 may be coupled to the top of the upper cross plate 42. Inside the sprocket housing 112 is a sprocket 114. The sprocket 114 may contain teeth that mesh with the chain 100, wherein one portion of the chain 100 enters the sprocket housing 112 and another portion of the chain 100 exits the sprocket housing 112. When the platform 20 of a powered hand truck 10 is being raised or lowered, the chain 100 will accordingly be in motion. The sprocket 114 rotates in a counterclockwise or clockwise manner as the chain 100 moves vertically to raise or lower the platform 20. The sprocket 114 can be constructed in any suitable fashion provided that it will withstand the loads placed upon it when the chain 100 is used to lift the platform 20 supporting a heavy object. The sprocket housing 112 protects the sprocket 114 and chain 100 while in motion and prevents outside objects from disrupting its motion. This sprocket housing 112 can additionally protect the powered hand-truck operator from injury while using the powered hand truck.

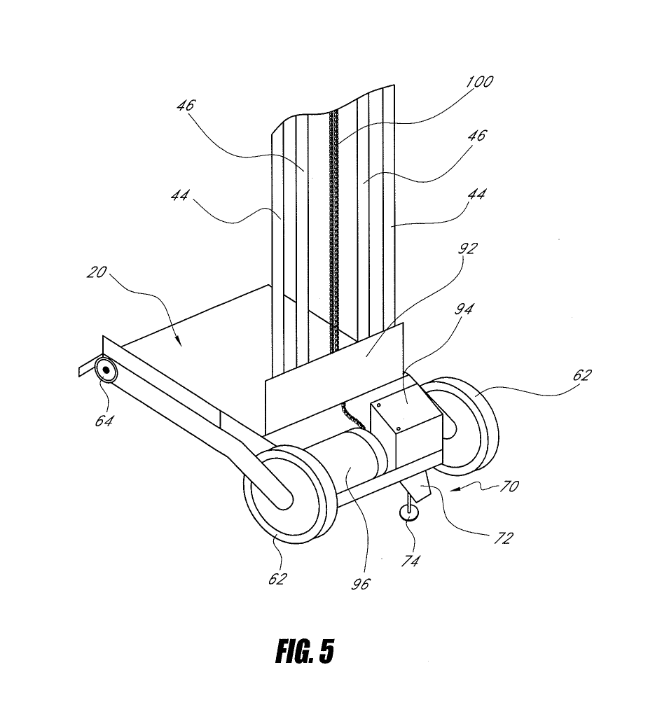

FIG. 5 illustrates a lower rear view of an embodiment of a powered hand truck with the movable platform 20 shown in its down position. The cover plate 92 is shown in its up position, which enables access to the battery 94 and the winch motor 96. The battery 94 supplies electrical energy that is used to enable operation of the winch motor 96. As an example, the battery 94 may comprise two standard 6-volt batteries connected in series to form a 12-volt battery. However, as will be clear to the skilled artisan in view of the present disclosure, the battery 94 may comprise a variety of battery types, including those of varying size, voltage output, maximum current output, and quantity of stored electrical energy, so long as the battery is paired with a compatible electric motor. In addition, in one embodiment, when the electrical energy of the battery 94 is depleted, the battery 94 may be replaced with a fresh battery. In an alternative embodiment, the battery 94 may comprise a rechargeable battery, in which the battery 94 may be removed for charging and replaced after it is fully charged. In an additional alternative embodiment, the battery 94 may comprise a rechargeable battery, and the powered hand truck 10 may be configured to receive AC power that would be used to recharge the battery 94 as needed. Furthermore, in other embodiments, the winch motor 96 may be configured to receive power from an external power source as well.

In one embodiment, the winch motor 96 is configured to receive DC electrical power from the battery 94. In addition, the winch motor 96 may be coupled to one end of the chain 100. For example, a system of one or more sprockets (not pictured) may be used to couple one end of the chain 100 to the winch motor 96. The torque output of the winch motor 96 enables the chain 100 to raise and lower the platform 20. In a preferred embodiment, the winch motor 96 is selected to be capable of lifting a load of at least 200 pounds. For example, the winch motor 96 may be the Northern Industrial Tools Electric Utility Winch Model No. 400195A. In one embodiment, one or more sprockets may be used to couple the chain 100 to the winch motor 96. In view of the present disclosure, it will be understood by a skilled artisan that as the chain 100 is wound up, the platform 20 will be raised, and as the chain 100 is unwound, the platform 20 will be lowered. In addition, in view of the present disclosure, a skilled artisan will understand that in alternative embodiments, various combinations of different types of batteries and electric motors may be used to engage the chain 100 to lift and lower the platform 20.

As shown in FIG. 5, the powered hand truck may include a brake 70 configured to stop the powered hand truck from rolling forwards or backwards. In the illustrated embodiment, the brake 70 comprises a foot pedal 72 configured to press a pedestal 74 downward against a ground surface. In an alternative embodiment, one or more brakes can be provided to prevent rotation of one or both of the rear wheels 62. For example, such a brake could include clamps, calipers, or other devices configured to grip the rear wheels 62, or press against the wheels in a manner that prevents the wheels from rotating.

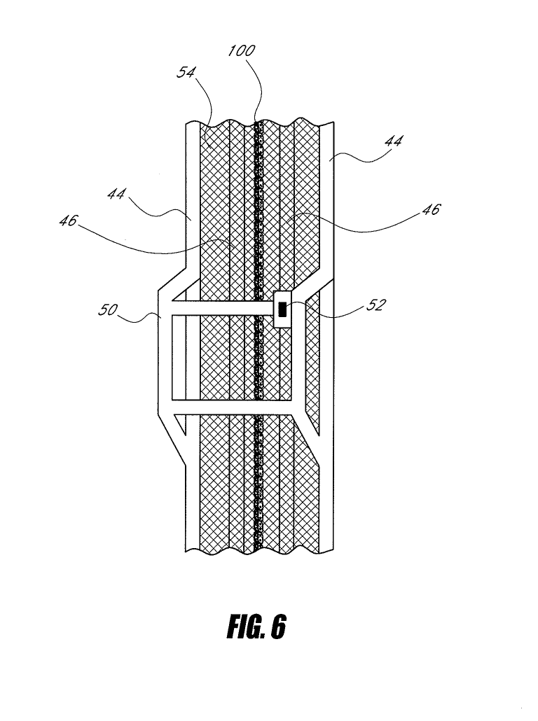

FIG. 6 illustrates a rear view of a middle section of an embodiment of a powered hand truck. In the illustrated embodiment, the handle 50 is shown extending rearward from the side members 44 of the frame and includes a switch 52. The switch 52, which may be electrically coupled to the winch motor 96, enables the operator of the powered hand truck to control the ascent and descent of the platform. For example, the switch 52 may feature three physical positions. In one embodiment, the middle position of the switch 52 may correspond to the platform 20 remaining motionless. The bottom position of the switch 52 may correspond to the platform 20 being lowered. The top position of the switch 52 may correspond to the platform 20 being raised. In alternative embodiments, the switch 52 may be placed in other locations. For example, in alternative embodiments, the switch 52 may be located on the side members 44. In other alternative embodiments, the switch 52 may be configured to enable selection of multiple speeds for the raising and lowering of the platform 20. Alternatively, selection of multiple speeds for the raising and lowering of the platform 20 could be enabled by a second switch.

A skilled artisan will appreciate that the platform 20 may not be positioned above its maximum height or below ground level. Thus, in one embodiment, the powered hand truck may be provided with an override mechanism whereby if the switch is in a position to cause the platform 20 to move downward, and the platform 20 has reached ground level, the switch will automatically switch to its off state. Alternatively, the powered hand truck may be provided with an override mechanism whereby if the switch is in a position to cause the platform 20 to move upward, and the platform 20 has reached its maximum height, the switch will automatically switch to its off state.

In alternative embodiments, the powered hand truck may include separate up and down buttons to control the ascent and descent of the platform 20. For example, the powered hand truck may include a dedicated up button that can be pressed and held to cause the platform 20 to be raised. Likewise, the powered hand truck may include a dedicated down button that can be pressed and held to cause the platform 20 to be lowered. When the operator is not pressing and holding the up or down button, the platform 20 may remain stationary, thereby preventing inadvertent movement of the platform 20. In addition, the separate up and down buttons may be located far apart. For example, the up button may be located on one side of the handle 50, while the down button is located on the other side of the handle 50. In addition, to prevent confusion between the up and down buttons, the up and down buttons may be different colors.

As shown in FIG. 6, in one embodiment, the powered hand truck may include a protective steel cage 54 that protects the operator of the powered hand truck from accidentally contacting the chain 100 while it is moving. Preferably, the mesh pattern of the steel cage 54 is spaced closely enough such that it would not be possible for the operator of the hand truck to accidentally place his or her fingers through the steel cage 54 while the powered hand truck is being operated. In addition, the steel cage 54 prevents objects from interfering with the chain 100 of the lifting and lowering mechanism. In alternative embodiments, the chain 100 may be protected through enclosure by a solid plate, or through a series of bars.

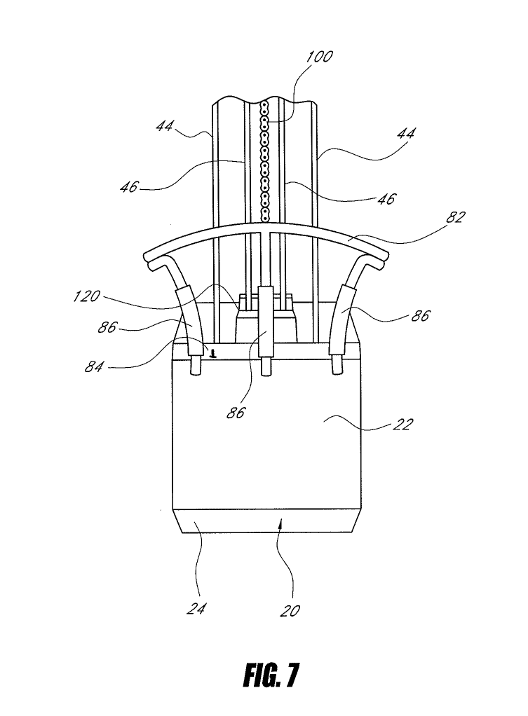

FIG. 7 illustrates a lower front section of an embodiment of a powered hand truck. In one embodiment, a support bar 82 may be provided to prevent the beer keg, or other heavy object, from interfering with the movement of the chain 100 of the lifting and lowering mechanism. In some embodiments, a keg or other weight may be strapped to the support bar 82 while the platform 20 is in motion or the powered hand truck is being maneuvered. Additionally, if desired, the support bar 82 can be provided with protective bumpers 86 to contact a surface of a keg or container (not shown). For example, the protective bumpers 86 may be constructed from a foam protective material.

In one embodiment, as shown in FIG. 7, the platform 20 may include a manual lock 84 to lock the platform 20 in a desired position. The manual lock 84 can comprise a pin that can be slid rearward to engage a hole in a portion of the frame of the powered hand truck. In alternative embodiments, other manual locks, such as clamps, latches, and clips, may be used to maintain the platform 20 in a desired position. In alternative embodiments, one or more manual locks can be provided to secure the platform in additional positions. In addition, as a safety feature, the pin could be spring based to automatically lock into place whenever the platform 20 is in the raised or lowered positions. In this embodiment, the operator of the powered hand truck 10 would need to remove the pin from the locked position before raising or lowering the platform 20.

When the platform 20 is in the raised or lowered positions, the powered hand truck 10 will be stably supported by the stabilization legs 36 and the rear wheels 62. The powered hand truck 10 can then be moved forwards or backwards while remaining vertically oriented, so as to position the hand truck in a desired location relative to the truck from which kegs may be lowered. In embodiments in which a brake is provided, it can be set to prevent the powered hand truck 10 from rolling from the desired position. Once a keg is lowered on the platform 20 to the down position, the powered hand truck 10 can be operated in a conventional manner by tipping the top portion of the powered hand truck 10 rearward, and rolling the powered hand truck 10 on the rear wheels 62. When the powered hand truck 10 is tipped rearward, a keg placed on the platform will lean against the support bar 82. If desired, a keg or other load can be strapped to the support bar 82 to prevent the load from undesirably shifting on the platform.

In one embodiment of a method of use, the powered hand truck 10 can be positioned on the ground adjacent to a truck loading surface, and oriented upright. The platform 20 can then be raised to the desired height by operating the switch 52. The powered hand truck 10 can then be moved forwards to a position in which the platform 20 overlaps a portion of the truck loading surface. In one embodiment, the platform 20 can be raised to a position substantially above a truck loading surface in order to receive a keg on an upper stack. Once the platform is in the desired position, a keg can be loaded onto the platform, and the platform can be lowered by operating the switch 52. In a situation where the platform 20 overlaps the truck loading surface, the powered hand truck 10 can be moved backwards while remaining in an upright position. Once the path between the platform 20 and the ground is clear, the platform 20 can be lowered completely to the ground, and the keg can be unloaded at ground level.

As will be clear to the skilled artisan in view of the present disclosure, the system components need not be identical to those shown in the illustrations. For example, while the powered hand truck has been described as using a chain to transmit force from the motor to the platform, the skilled artisan will appreciate how to modify the system using alternative load-bearing elements, such as a rope or wire. In addition, although the powered hand truck has been described with respect to an electric winch motor, the skilled artisan will appreciate how to modify the system using other motors, such as a winch motor powered by hydraulic, pneumatic, or internal combustion drives.

Although certain embodiments and examples have been described herein, it will be understood by those skilled in the art that many aspects of the methods and devices shown and described in the present disclosure may be differently combined and/or modified to form still further embodiments. Additionally, it will be recognized that the methods described herein may be practiced using any device suitable for performing the recited steps, and the devices described herein can be used in other applications beyond those described. Such alternative embodiments and/or uses of the methods and devices described above and obvious modifications and equivalents thereof are intended to be within the scope of the present disclosure. Thus, it is intended that the scope of the present invention should not be limited by the particular embodiments described above, but should be determined only by a fair reading of the claims that follow.

What is claimed is:

1. A powered hand truck comprising:
a frame having an upper portion, a lower portion, and a longitudinal axis extending between the upper portion and the lower portion;
at least one handle mounted to the frame adjacent to the upper portion;
a pair of rear wheels attached to the frame adjacent to the lower portion;
a platform having a substantially planar upper surface that is oriented substantially perpendicular to the longitudinal axis of the frame, wherein the platform is configured to move axially along said longitudinal axis while maintaining said perpendicular orientation;
an electric winch motor mounted to the frame adjacent to the lower portion;
a switch that enables selection of one of at least three states, wherein a first state causes the platform to be raised, a second state causes the platform to be lowered, and a third state causes the platform to neither be raised nor lowered;
a battery electrically coupled to the electric winch motor to supply power thereto;
a chain, wherein one end of the chain is coupled to the electric winch motor and the other end of the chain is coupled to the platform;
a brake configured to lock at least one of the rear wheels from rotation;
a steel cage, wherein the steel cage is mounted to the frame and encloses the chain;
at least one stabilizing leg extending forward from the frame, said at least one stabilizing leg comprising a front wheel attached thereto, said at least one stabilizing leg additionally comprising a rubber bumper configured to absorb and dissipate energy; and
a support bar mounted to the platform, wherein the support bar comprises a protective bumper.

2. The powered hand truck of claim 1, wherein the platform is configured to raise or lower a weight of up to about 170 pounds between a ground level and a height of about 68″.

3. The powered hand truck of claim 2, wherein the platform is configured to raise and lower the weight at a controlled rate.

4. The powered hand truck of claim 1, wherein the platform comprises an upper surface with a width of about 19″ and a depth of about 19″.

5. The powered hand truck of claim 1, wherein the platform is configured to support a beer keg.

6. A device comprising:
a frame comprising at least one vertical frame member, wherein the frame has a pair of wheels mounted to a bottom portion thereof;
at least one handle mounted to the frame and extending rearwardly;
at least one stabilizing leg mounted to the bottom portion of the at least one frame member and extending forwardly;
a planar platform movably attached to the frame and extending forwardly from the at least one frame member, the platform being configured to move vertically along the vertical frame member;
a motor mounted adjacent to the bottom portion of the at least one frame member; and
a switch that enables selection of one of at least three states, wherein a first state causes the platform to be raised, a second state causes the platform to be lowered, and a third state neither causes the platform to be raised nor lowered.

7. The device of claim 9, further comprising a chain, wherein one end of the chain is coupled to the motor and the other end of the chain is coupled to the platform.

8. The device of claim 9, further comprising a rechargeable battery electrically coupled to the motor to supply power thereto.

9. The device of claim 11, wherein the rechargeable battery is a 12 volt battery.

10. The device of claim 9, wherein the motor is configured to raise or lower a weight of up to about 170 pounds atop the platform between a ground level and a height of about 68″.

11. The device of claim 9, wherein the switch may enable selection of more than one speed of raising and lowering of the platform.

12. The device of claim 9, wherein the platform comprises an upper surface with a width of about 19″ and a depth of about 19″.

13. The device of claim 9, further comprising a brake configured to lock at least one of the wheels from rotation.

14. The device of claim 9, further comprising a brake configured to lock both of the wheels from rotation.

15. A method of lowering a weight from a height, the method comprising:
placing a weight on a raised platform that is vertically movable on a hand-truck frame, the hand truck frame also comprising at least one wheel mounted to a lower portion thereof;
pressing a switch that controls a winch motor to a first position, wherein pressing the switch to the first position causes the winch motor to lower the weight on the platform to a ground level;
pressing the switch to a second position, wherein pressing the switch to the second position causes the winch motor to cease lowering the weight on the platform;
removing the weight from the platform.

16. A method of raising a weight to a height, the method comprising:
placing a weight on a platform that is vertically movable on a hand-truck frame, the hand truck frame also comprising at least one wheel mounted to a lower portion thereof;
pressing a switch that controls a winch motor to a first position, wherein pressing the switch to the first position causes the winch motor to raise the weight on the platform;
pressing the switch to a second position, wherein pressing the switch to the second position causes the winch motor to cease raising the weight on the platform;
removing the weight from the platform.
